(19) United States
(12) Patent Application Publication
(10) Pub. No.: US 2005/0116466 A1
(43) Pub. Date: Jun. 2, 2005

(54) Flat-surface quick coupling tubes extending between a pressurized fluid user device and a fluid feeding means

(76) Inventor: Massimo Arosio, Treviglio (Bg) (IT)

Correspondence Address: Kirschstein, Ottinger, Israel & Schiffmiller, P.C., 489 Fifth Avenue, New York, NY, 10017-6105, US

(21) Appl. No.: 10/999,342

(22) Filed: Nov. 30, 2004

(30) Foreign Application Priority Data
Dec. 2, 2003 (IT) MI2003A-002348

(51) Int. Cl. F16L 55/00

(52) U.S. Cl. 285/80

(57) ABSTRACT

A flat-surface quick coupling for coupling tubes extending between a pressurized fluid user device and fluid feeding means comprises a quick coupling (2) female part (1) and a quick coupling (2) male part (12), to which are coupled concentric tubes for providing a delivery duct and a return duct for a hydraulic fluid, the ducts delimited by the concentric tubes being operatively coupled to a delivery duct, respectively a return duct, made inside the quick coupling parts (1) and (12), said ducts, upon assembling the female part (1) and male part (12) being mutually operatively connected.

### BACKGROUND OF THE INVENTION

The present invention relates to a flat-surface quick coupling for coupling tubes extending between a pressurized fluid user device and a fluid feeding means.

Is already known in the prior art to use quick couplings for coupling flexible hoses to an user device, such as an actuator device provided in an agricultural apparatus or a civil building apparatus, for example a grader or an excavator.

Actually, in these machines resilient tubes or hoses for supplying through a delivery tube a hydraulic fluid, e.g. a highly pressurized oil, to an user, such as a cylinder/piston unit or hydraulic motor, are used.

To recover or return the hydraulic fluid from the user to the pressure source, such as a pump, it is indispensable to also provide a fluid return tube.

Thus, from the prior art is already known to use two separated flexible tubes or hoses provided, at their end portions, with quick couplings for coupling an user device to a pressure source.

It is moreover frequently necessary to disconnect the fluid delivery tube and fluid return tube from a set user, for example to replace an operating tool, or to carry out servicing operations to said operating tool.

Considering that in the past it was conventional to use two separated tubes having a delivery function, respectively a return function, and considering that the coupling operations were to be performed in dirty environments and, moreover, that the pressurized fluid tube connecting operations were to be performed with a comparatively high speed, the delivery tube could be erroneously connected to a hydraulic fluid return fitting or vice versa, with the risk of a failure of the auxiliary apparatus or of irreparable damages.

Finally, a further drawback of prior quick coupling for coupling a delivery tube separated from a return tube, was the necessity of providing two pairs of quick couplings, thereby greatly increasing the system cost.

### SUMMARY OF THE INVENTION

The main object of the present invention is to overcome the above mentioned drawbacks of the prior art, by allowing to use a single quick coupling, both for the pressurized fluid delivery line and return line, while allowing a quick and simple coupling to be obtained, while absolutely preventing any assembling errors in resilient tube connecting operations from occurring.

The above object is achieved by a flat-surface quick coupling for coupling tubes extending between a pressurized fluid user device and a fluid feeding means, characterized in that to a female part of the flat-surface quick coupling and a male part of said flat-surface quick coupling are coupled mutually concentric tubes to provide a hydraulic fluid delivery duct and a hydraulic fluid return duct, and that the ducts delimited by said concentric tubes are operatively coupled to a fluid delivery duct, respectively a fluid return duct, said ducts being made inside said female quick coupling part and male quick coupling part, and that said ducts, upon assembling said quick coupling parts, are mutually operatively connected.

### BRIEF DESCRIPTION OF THE DRAWINGS

The subject matter according to the present invention will be disclosed in a more detailed manner hereinafter and illustrated by an embodiment thereof, given only by way of an example, and shown in the accompanying drawings, where:

FIG. 1 is a partially cross-sectioned view illustrating the female part of the novel quick coupling;

FIG. 2 is a partially cross-sectioned view illustrating the male part of the novel quick coupling;

FIG. 3 is a partially cross-sectioned view showing the components of the quick coupling at the start of the coupling operation or step;

FIG. 4 is a partially cross-sectioned view illustrating the quick coupling components in an operatively connected condition; and

FIG. 5 shows the quick coupling components at the end of the connecting operation or step, with the flow ducts in an opened condition to allow the hydraulic fluid to flow therethrough.

### DESCRIPTION OF THE PREFERRED EMBODIMENTS

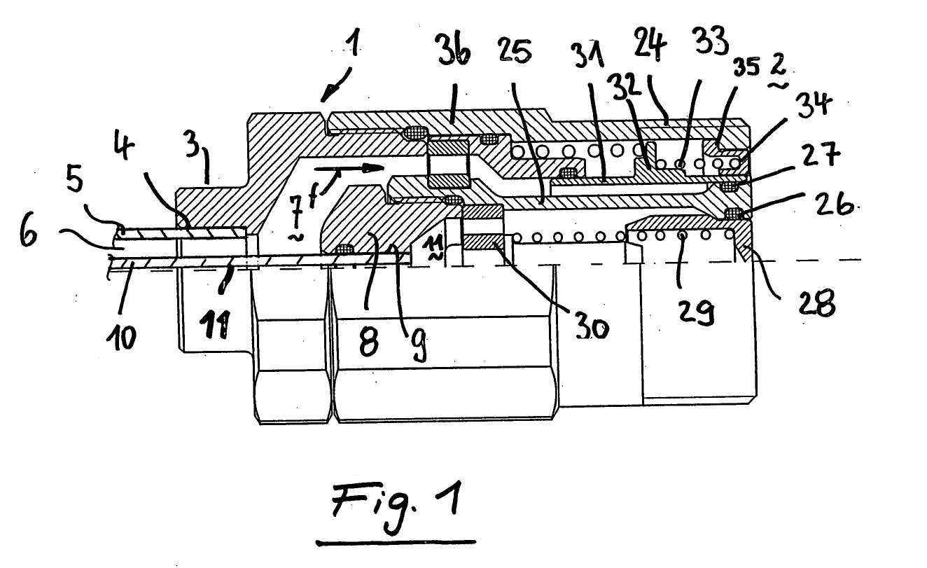

As shown in FIG. 1, the female part 1 of the flat-surface quick coupling, generally indicated by 2, comprises an end fitting 3, including an inner recess 4 for engaging therein an end portion of a resilient tube or hose 5, defining a first annular duct 6.

The annular duct 6 is coupled to a further duct 7 formed inside the body of the female part 1.

Inside said female part 1 is provided a ring-nut 8 defining a recess 9 for engaging therein an end portion of a second resilient tube or hose 10, leading to a duct 11 formed inside said female part 1.

The fluid delivery and return tubes 5 and 10 are arranged coaxially with respect to one another.

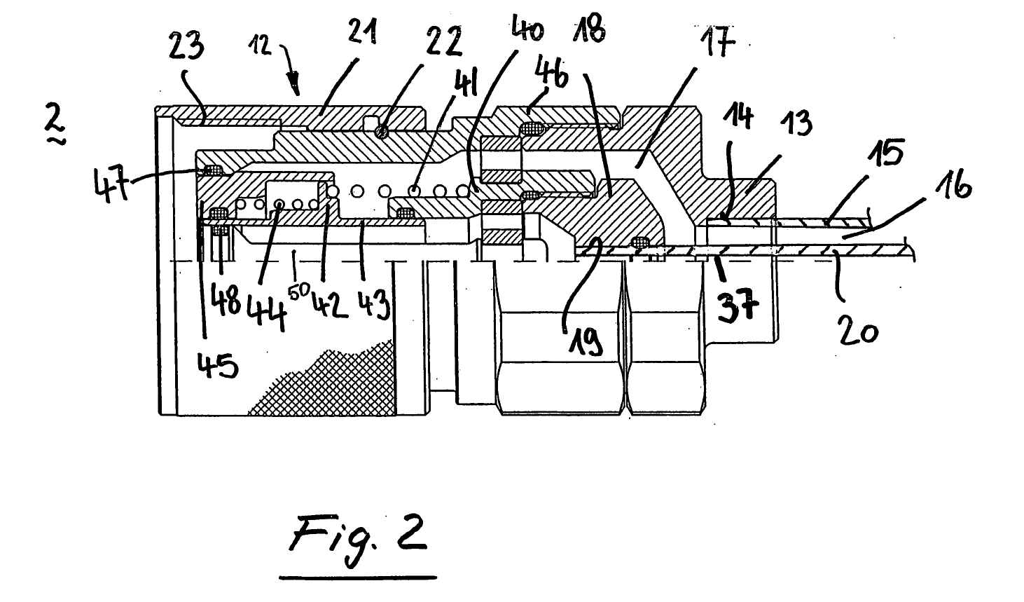

FIG. 2 is a partially cross-sectioned view showing the male part 12 of the quick coupling, also indicated by the reference number 2.

The quick coupling 2 comprises an end fitting 13 having an inner recess 14 in which is engaged a flexible hose or tube 15 defining a first hydraulic fluid flow duct 16 leading to a duct 17 delimited by an insert 18, including a recess 19 therein is engaged an end portion of a further flexible tube or hose 20 defining a further duct 37.

The fitting 12 rotatably houses a ring-nut 21 locked at an axial position by a resilient ring element 22.

The rotary ring-nut 21 comprises, on a front side thereof, an inner thread 23 allowing the two quick coupling parts 1, 12 to be coupled, as the ring nut 21 is screwed on the outer thread 24 of the female part 1.

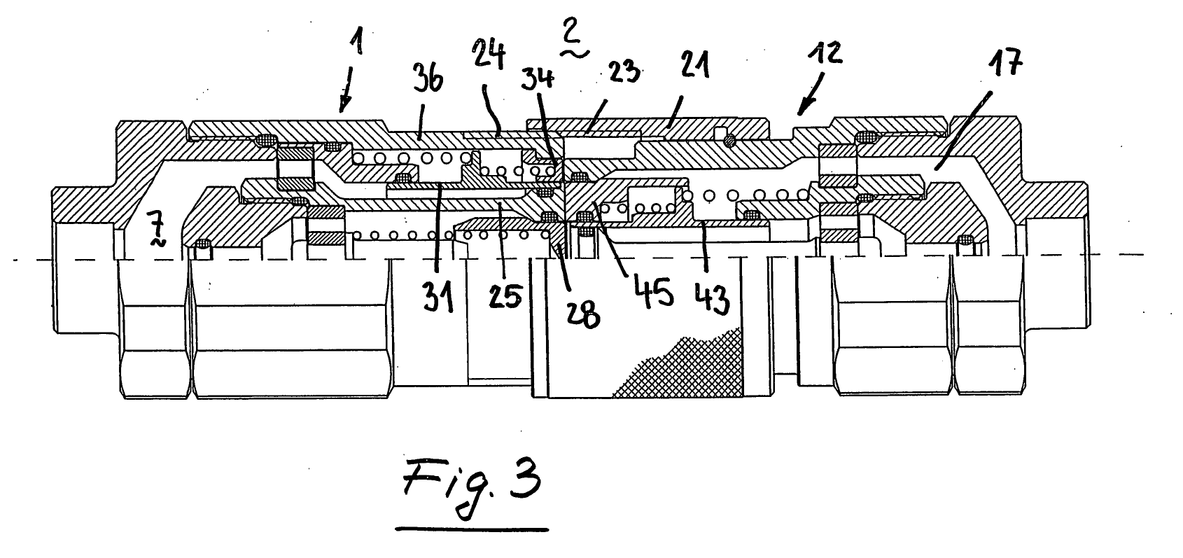

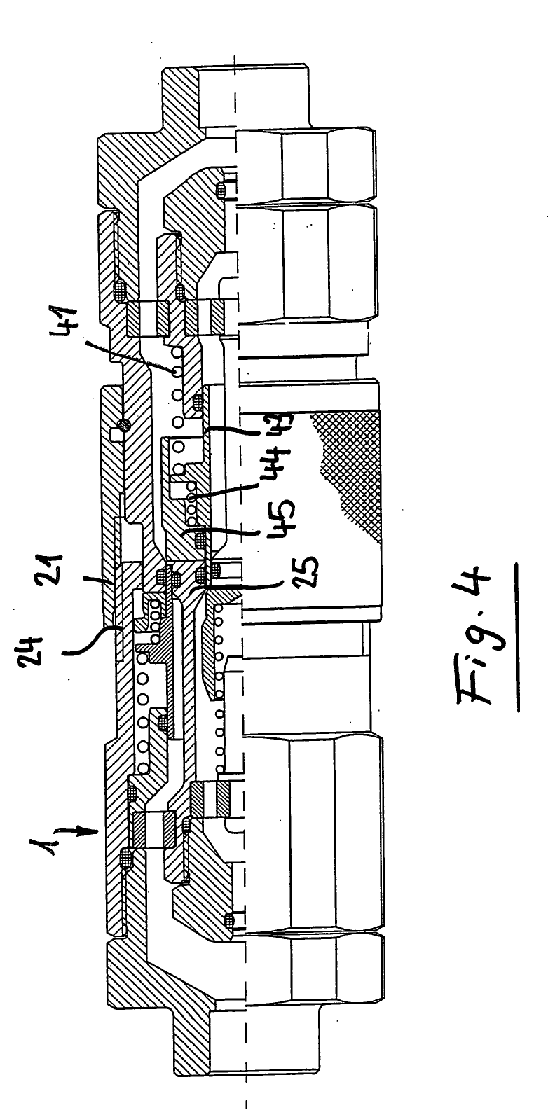

The coupling steps for coupling the female part 1 and male part 12 are shown in FIGS. 3, 4 and 5.

FIG. 1 shows moreover that the female part 1 comprises a locally fixed inner tubular stem 25, known per se in the prior art. The tubular stem 25 operates as a separating element for the ducts 7, 11. As shown, the stem 25 comprises a front enlarged portion engaging an inner annular gasket 26, and an outer annular gasket 27.

The inner annular gasket 26 is contacted by a tubular sliding ring nut 28, urged by an urging preloaded spring 29 bearing against a perforated bush 30, rigid with the end portion of the stem 25. Against the outer annular gasket 27 is abutted a movable tubular element 31, having a circumferential enlarged or bulged portion 32, thereagainst abuts a spring 33 which on a front side thereof is encompassed by a movable ring gear 34 which, at an abutment point 35, abuts against an outer tubular body 36 of the female part 1.

FIG. 2 shows that the quick coupling male part 12 supports in its inside, through the enlarged portion 18, a tubular element 40 which is locally fixed.

Against said tubular element 40 abuts a spring 41, thereagainst abuts an enlarged portion 42 of an axially movable tubular element 43 and which, on the front side thereof, is encompassed by a spring 44 thereagainst a further tubular element 45 abuts. Between the tubular element 43, the tubular element 45 and front end portion of the body 46, a series of gaskets 47 and 48 are provided.

The constructional elements 42, 43 and 45 are held in their proper position by a central stem 50.

At the start of the coupling operation for coupling the quick coupling parts 1 and 12, as shown in FIG. 3, the thread 23 of the rotary ring nut 21 is brought into engagement with the outer thread 24 of the tubular body 36. All the movable elements 34, 28 and 31 as well as 45 and 43, by way of an example, are yet in their starting positions and the ducts 7, respectively 17, are shut-off, and, accordingly, no delivery or return hydraulic fluid flow will occur therethrough.

By further screwing on the ring nut 21 of the thread 24, the stem 25 causes the tubular body 45 to be backward displaced against a spring 44, which will be consequently preloaded. In the meanwhile, the tubular body 43 is also moved backward against an urging spring 41 which is also preloaded.

This effect is obtained since the tubular elements 45 is driven by the stem 25 included in the female part 1. Simultaneously the tubular element 43, sliding along a stem 50 which is locally fixed inside the male part 12, is axially displaced, thereby disengaging the duct 9.

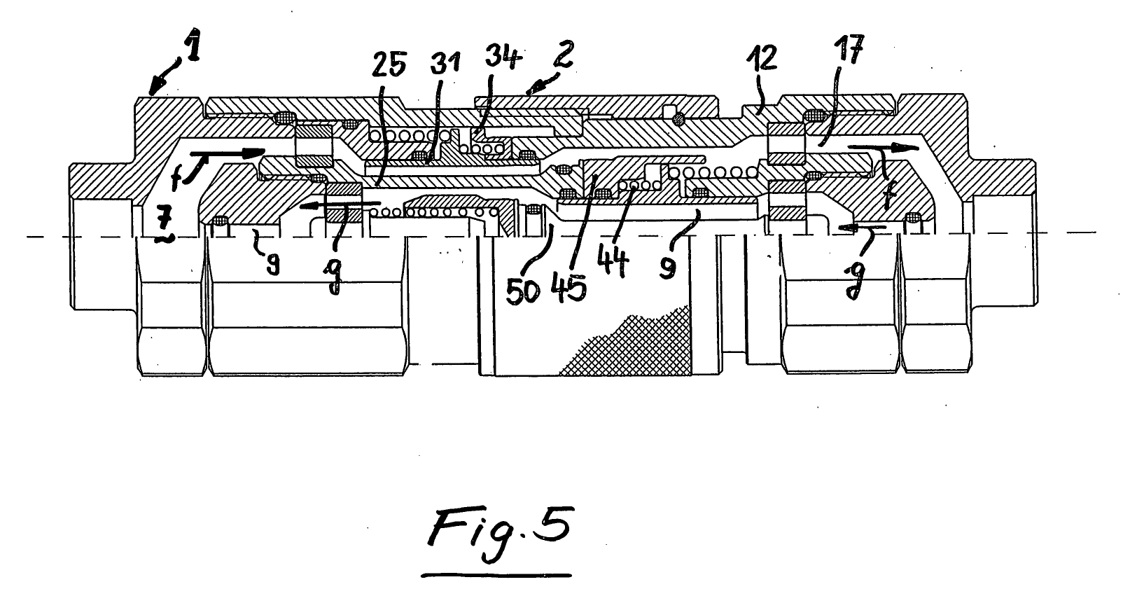

In FIG. 5, the female part 1 is fully coupled to the male part 12. Owing to the operation of the locally fixed stem 25, the body 45 has been backward displaced against the urging spring 44 which is preloaded and, owing to the operation of the body 46, also the ring nut 34 and tubular body 31 will have been driven toward the rear or back part of the female part 1, thereby disengaging or clearing the duct 7 while allowing an unhindered hydraulic fluid flow through the duct 7, in the direction indicated by the arrows (f) in FIG. 5.

Simultaneously, since also the duct 9 has been fully cleared, it will be possible to provide return fluid, as shown by the arrows (g) in FIG. 5.

Thus, a quick coupling 2 including the quick coupling parts 1 and 12 allows, for the first time, to use concentric tubes 5 and 10, and thereby allowing a delivery flow and a return flow inside a single quick coupling 2.

1. A flat-surface quick coupling for coupling tubes extending between a pressurized fluid user device and a fluid feeding means, characterized in that said quick coupling (2) comprises a quick coupling female part (1) and a quick coupling male part (12) to which are connected concentric tubes (5, 10, 15, 20) so as to provide a hydraulic fluid delivery duct (6, 16) and a hydraulic fluid return duct (11, 37), and that the ducts defined by said concentric tubes (5, 10, 15, 20) are operatively coupled to a fluid delivery duct (7) respectively a fluid return duct (17) provided inside said female part (1) and male part (12) and that said ducts (7, 17), upon assembling said male and female parts (11, 12), are mutually operatively connected.

2. A flat-surface quick coupling according to claim 1, characterized in that said male part (12) rotatively houses a ring nut (21) adapted to be locked at an axial position thereof by a resilient ring element (22), and that said ring-nut (21) comprises a front inner thread (23) to be coupled with a thread (24) of said female part (1).

3. A flat-surface quick coupling according to claim 1, characterized in that said stem (25) operates as a guide element for a movable tubular element (31) including a circumferential enlarged portion (32) thereagainst abuts a spring (33) encompassed, on a front side thereof, by a movable ring gear (34), said ring gear (34) being brought into abutment with an outer tubular body (36) of said female part (1).

4. A flat-surface quick coupling according to claim 1, characterized in that said male part (12) supports in an inside thereof, through and enlarged portion (18), a locally fixed tubular element (40) and that against said tubular element (40) abuts a spring (41) thereagainst abuts an enlarged portion (42) of an axially movable tubular element (43), which, on a front side thereof, is encompassed by a spring (44) thereagainst a further tubular element (45) bears.
